(19) United States
(12) Patent Application Publication
(10) Pub. No.: US 2015/0029756 A1
(43) Pub. Date: Jan. 29, 2015

(54) DISPLAY APPARATUS

(71) Applicant: Sharp Kabushiki Kaisha, Osaka (JP)

(72) Inventors: Shigenori Tanaka, Osaka (JP); Yoshinobu Hirayama, Osaka (JP); Toshihiro Yanagi, Osaka (JP)

(73) Assignee: SHARP KABUSHIKI KAISHA, Osaka (JP)

(21) Appl. No.: 14/376,393

(22) PCT Filed: Jan. 28, 2013
(86) PCT No.: PCT/JP2013/051770

§ 371 Date: Aug. 1, 2014

(30) Foreign Application Priority Data
Feb. 2, 2012 (JP) 2012-021248

(51) Int. Cl. G02F 1/1333

(52) U.S. Cl. CPC G02F 1/133308; G02F 1/133382; G02F 1/133345
USPC 362/633

(57) ABSTRACT

A frame includes a frame portion that surrounds the planar light source device inside of the bezel, and that has the display panel placed thereon, and insulating portions that are individually fitted into slits respectively of the bezel, and that have an side face facing a display panel, and the side face facing a display panel is closer to the display panel than a side face of the bezel facing the side face of the display panel.

### TECHNICAL FIELD

The present invention relates to a display device.

### BACKGROUND ART

Portable information devices such as laptop computers, personal data assistants (PDA), portable video game devices, and cellular phones have been widely prevalent in recent years. In such portable information devices, liquid crystal display devices are widely used as the display. Liquid crystal display devices mainly include a backlight unit and a liquid crystal display element, and have a planar light source device as the backlight unit and a liquid crystal panel as the liquid crystal display element.

In the liquid crystal display device, in order to facilitate assembly of the liquid crystal display device and to mitigate heat from the planar light source device, the planar light source device and the liquid crystal panel are commonly housed in a bezel made of SUS, aluminum, tin, or the like. In such a case, wiring members are sometimes exposed in a side face of a glass plate of a liquid crystal panel, and an electrical short may occur when wiring members come into contact with the bezel made of metal, which may cause an adverse effect in display quality. Further, it is desirable to protect the glass plate of the liquid crystal panel.

One method to avoid such problems in a liquid crystal display device is to insulate the liquid crystal panel from the bezel by utilizing a frame on which the liquid crystal panel is placed. The frame on which the liquid crystal panel is placed is generally made of a resin such as polycarbonate (PC) and polymethyl methacrylate resin (PMMA) and is disposed so as to surround a planar light source device inside of a bezel, and the liquid crystal panel is placed thereon. FIG. 7 shows a partial cross-sectional view of a liquid crystal display device having a frame that insulates the liquid crystal panel from the bezel.

As shown in FIG. 7, a frame 28 includes a rib-shaped insulating portion 28a, and the insulating portion 28a is interposed between a bezel 29 and a liquid crystal panel 30b. With this configuration, it is possible to prevent contact of a wiring member with the bezel 29 of the liquid crystal panel 30b and to protect a glass plate of the liquid crystal panel 30b.

However, thicknesses of the bezel and frame and clearances between the respective members are necessary in order to insulate the liquid crystal panel 30b from the bezel 29 by utilizing the insulating portion 28a of the frame 28, which necessitates a widening of the frame of the liquid crystal display device 21 (areas of the liquid crystal display device 21 other than the display area).

Patent Document 1 discloses a method for insulating a liquid crystal panel from a bezel without the use of a frame. FIG. 8 shows a partial cross-sectional view of a liquid crystal display device disclosed in Patent Document 1.

As shown in FIG. 8, a liquid crystal display device 31 disclosed in Patent Document 1 includes an insulating thin sheet 33 that has a larger area than the base of the liquid crystal display device 31 under a frame 38 on which a liquid crystal panel 40b is placed, and at least one side of the sheet 33 is folded so as to cover wiring members exposed at a side face of the liquid crystal panel 40b. This enables the prevention of an electrical short between the wiring member and a bezel 39 of the liquid crystal panel 40b and also allows for narrowing of a frame of the liquid crystal display device 31.

### RELATED ART DOCUMENT

### Patent Document

Patent Document 1: Japanese Patent Application Laid-Open Publication, “Japanese Patent Application Laid-Open Publication No. 2010-134120 (Published on Jun. 17, 2010)”

### SUMMARY OF THE INVENTION

### Problems to be Solved by the Invention

In a method disclosed in Patent Document 1, although a portion of the insulating thin sheet 33 is folded so as to cover the side face of the liquid crystal panel 40b, it is necessary for only a few millimeters of the sheet 33 to be folded because the thickness of the liquid crystal panel 40b is generally a few millimeters. However, it is not easy for the sheet 33 to be folded since its thickness is less than or equal to 0.1 millimeter and a manufacturing cost may increase due to very poor work productivity. Further, an end portion of the folded sheet (an area A shown in FIG. 8) is more likely to be bent, and thus, there is a risk of a defect such as the sheet 33 being stuck in the fold as the liquid crystal panel 40b is being assembled. These problems may also arise in display devices other than liquid crystal display devices.

The present invention takes into account the above-mentioned problems, and an object thereof is to provide a display device including a narrower frame with an improved shape.

### Means for Solving the Problems

In order to solve the above-mentioned problem, a display device according to one aspect of the present invention includes: a planar light source device; a display panel; a bezel that houses the planar light source device and the display panel, the bezel being made of metal and having a plurality of slits in side faces of the bezel; and a frame that includes: a frame portion that surrounds the planar light source device inside of the bezel, the frame portion having the display panel placed thereon such that the display panel is disposed over the planar light source device; and a plurality of insulating portions that are formed in an outer edge of the frame portion, the plurality of insulating portions individually being fitted into the plurality of slits respectively, a side face of each of the plurality of insulating portions respectively facing a side face of a display panel being closer than a face of the bezel facing the side face of the display panel to the display panel.

By the above-mentioned configuration, an inner side face of the insulating portion is closer to the display panel than an inner side face of the bezel. This prevents the bezel from coming into contact with the display panel and enables the insulation of the bezel from the display panel. Here, because the insulating portion of the frame is fitted into a slit of the bezel, compared to a conventional configuration, an outer side face (the inner side face) is located to the inside (inside of the bezel) without a change in the position of the frame. This makes it possible to narrow the frame of the display device.

In particular, the display device of one aspect of the present invention achieves a narrower frame area of the display device by only using the same frame as a conventional display device. Therefore, because the same components can be used as a conventional display device, the display device can be assembled with ease and the manufacturing cost can be kept low. Thus, one aspect of the present invention can provide a display device including a narrower frame area with an improved shape.

Additional objects, features, and effects of the present invention shall be readily understood from the descriptions that follow. Advantages of the present invention shall become apparent by the following descriptions with reference to the appended drawings.

### Effects of the Invention

According to a display device of one aspect of the present invention, the insulating portion can prevent the bezel from coming into contact with the display panel and can insulate the bezel from the display panel. Here, since the insulating portion of the frame fits into a slit of the bezel, compared to the conventional configuration, the external face (the inner face) is located to the inside (inside of the bezel) without the frame changing in position. As a result, it is possible to narrow the frame area of the bezel.

In particular, because a display panel of one aspect of the present invention is constituted from the same components of a conventional display panel, the display device can be assembled with ease and the manufacturing cost can be kept low. Accordingly, one aspect of the present invention makes it possible to narrow the frame with the improved shape.

### BRIEF DESCRIPTION OF THE DRAWINGS

FIG. 1 is a partial cross-sectional view showing a liquid crystal display device according to one embodiment of the present invention;

FIG. 2(a) is a perspective view of the bezel of one embodiment of the present invention, FIG. 2(b) is a perspective view showing a frame disposed to the inside of the bezel according to one embodiment of the present invention, FIG. 2(c) is a perspective view showing a planar light source device housed inside of the bezel according to one embodiment, FIG. 2(d) is a perspective view showing a liquid crystal display device according to one embodiment of the present invention;

FIG. 3(a) is a partial cross-sectional view of the liquid crystal display device showing a part on which an insulating portion of the frame is formed according to one embodiment of the present invention, FIG. 3(b) is a partial cross-sectional view of the liquid crystal display device showing a part on which an insulating portion of the frame according to one embodiment of the present invention is not formed;

FIG. 4(a) is a partial cross-sectional view of a conventional liquid crystal display, and FIG. 4(b) is a partial cross-sectional view of the liquid crystal display device according to one embodiment of the present invention;

FIGS. 5(a) to 5(d) show arrangement examples of insulating portions of a frame according to one embodiment of the present invention;

FIG. 6(a) is a partial cross-sectional view showing a liquid crystal display device according to another embodiment of the present invention, FIG. 6(b) is a partial cross-sectional view showing a liquid crystal display device to which the liquid crystal display device according to another embodiment has been varied, and FIG. 6(c) is a layout plan showing an end product into which a liquid crystal display device according to one embodiment of the present invention is built;

FIG. 7 is a partial cross-sectional view showing a conventional liquid crystal display device including a frame which insulates a liquid crystal panel from a bezel; and

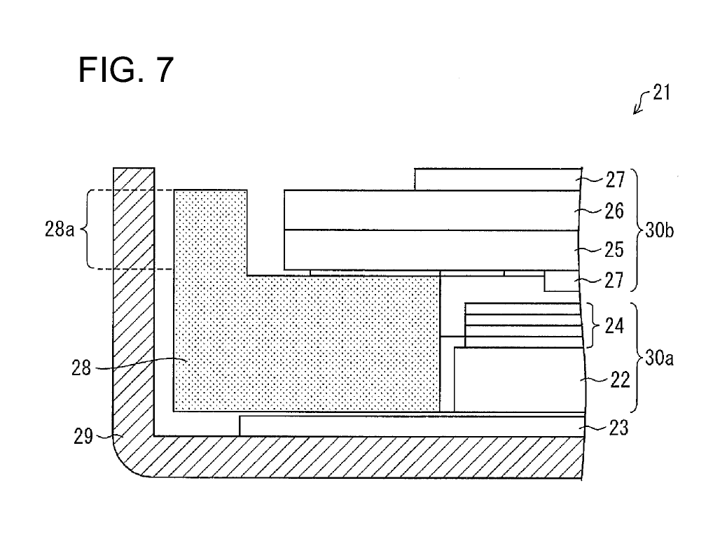

FIG. 8 is a cross-sectional view showing a conventional liquid crystal display device.

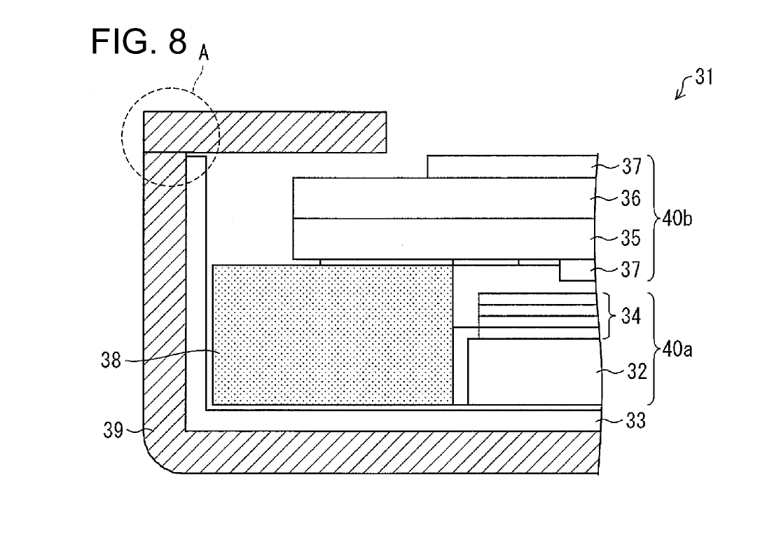

### DETAILED DESCRIPTION OF EMBODIMENTS

Embodiments of the present invention will be explained below with reference to drawings. In the following descriptions, members having the same functions and operations will be assigned the same reference characters, and descriptions thereof will be omitted.

### Embodiment 1

A display device of the present embodiment includes, for example, a liquid crystal display device, a MEMS (Micro Electro Mechanical Systems) display, or the like. In the descriptions below, a display device according to the present embodiment will be described as an example of a liquid crystal display device, but the present embodiment is not limited thereto.

(Configuration of Liquid Crystal Display Device 1)

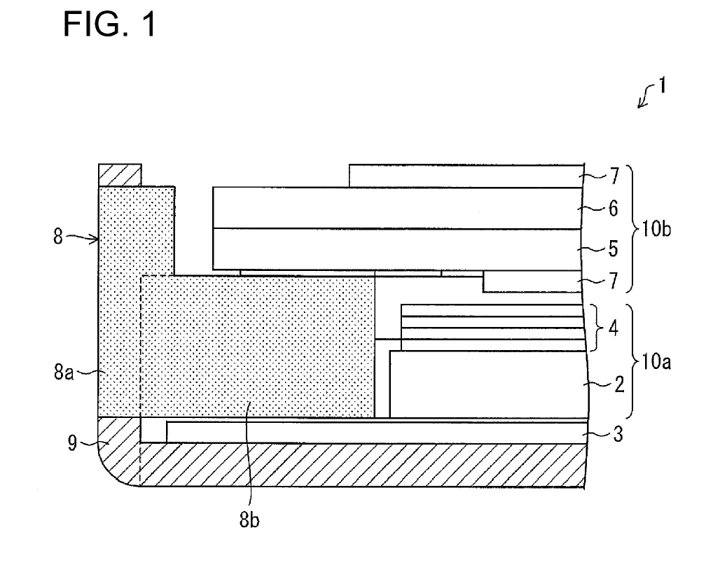

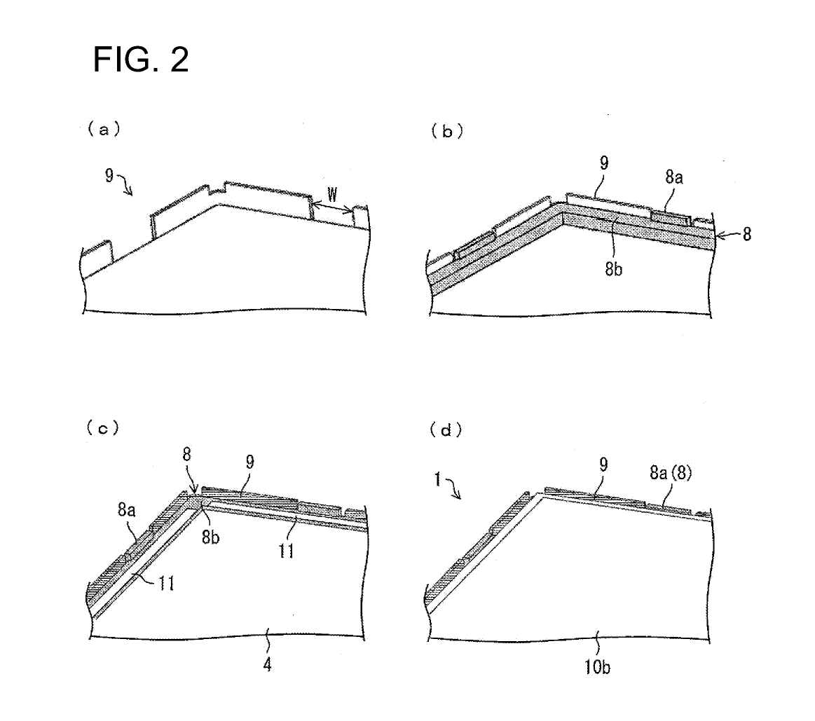

A configuration of a liquid crystal display device 1 according to the present embodiment will be described with reference to FIGS. 1 and 2. FIG. 1 is a partial cross-sectional view showing the liquid crystal display device 1, and FIG. 2(a) is a perspective view of a bezel 9, FIG. 2(b) is a perspective view showing a frame 8 disposed to the inside of the bezel 9, FIG. 2(c) is a perspective view showing a planar light source device 10a housed to the inside of the bezel 9, and FIG. 2(d) is a perspective view showing the liquid crystal display device 1.

As shown in FIG. 1, the liquid crystal display device 1 is constituted of a back light unit and a liquid crystal display element, and includes a planar light source device 10a as the back light unit and a liquid crystal panel (display panel) 10b as the liquid crystal display element. The planar light source device 10a includes a light guide plate 2, a reflection film 3, an optical film 4, and a light source (not shown). The light guide plate 2 is disposed above the reflection film 3, and the optical film 4 is disposed on the light guide plate 2. The planar light source device 10a includes a light emitting diode (LED), a laser diode (LD), a cold cathode fluorescent lamp (CCFL), or the like as the light source. In the planar light source device 10a, when the light source emits light, the light from the light source enters the light guide plate 2. The light from the light source undergoes multiple reflection inside of the light guide plate 2, and is emitted from the surface of the liquid crystal panel 10b of the light guide plate 2 (light-emitting surface). The light emitted from the light guide plate 2 is focused by the optical film 4 and is illuminated to the liquid crystal panel 10b. The light emitted from the light guide plate 2 is guided toward the liquid crystal panel 10b by the light guide plate 2 efficiently in the above-mentioned manner, and is focused by the optical film 4. As a result, an illumination distribution in the planar light source device 10a is evened out and it is possible to irradiate even light to the liquid crystal panel 10b. The reflection film 3 is a film for returning light that has leaked from the light guide plate 2 to the reflection film 3. The optical film 4 generally includes a lens seat, a diffusion seat, or the like. For example, the optical film may include a two prism system that has two lens sheets, each of which includes prism patterns that cross each other, interposed between two diffusion seats. Further, the optical film may include a reverse prism system that has one lens sheet having prism patterns in a downward direction.

On the other hand, the liquid crystal panel 10b includes a liquid crystal material sealed between a glass plate 15 in which thin film transistors (TFT), wires, and so on are formed and a glass plate 16 in which transparent electrodes, a color filter, and so on are formed, and respective polarizing plates 17 are disposed on each side of the glass plates 15 and 16.

In such a case, the liquid crystal display device 1 of the present embodiment houses the liquid crystal display device 1 in the bezel 9 which is made of metal such as SUS, aluminum, tin, or the like in order to facilitate assembly of the liquid crystal display device 1 and to mitigate heat from the planar light source device 10a. Specifically, first, the bezel 9 is prepared (shown in FIG. 2(a)), and on the inside of the bezel 9, the frame 8 is disposed. (shown in FIG. 2(b)). Next, the planar light source device 10a is disposed on the inside of the frame 8 (shown in FIG. 2(c)), then, the liquid crystal panel 10b is placed on the frame 8 through a double-sided tape 11 (shown in FIG. 2(d)). As described above, the liquid crystal panel 10b is placed on the frame 8. The frame 8 is generally made of a resin such as polycarbonate (PC), polymethyl methacrylate (PMMA), or the like and is disposed in the bezel 9 so as to surround the planar light source device 10a, and the liquid crystal panel 10b is placed thereon.

(Configuration of Frame 8)

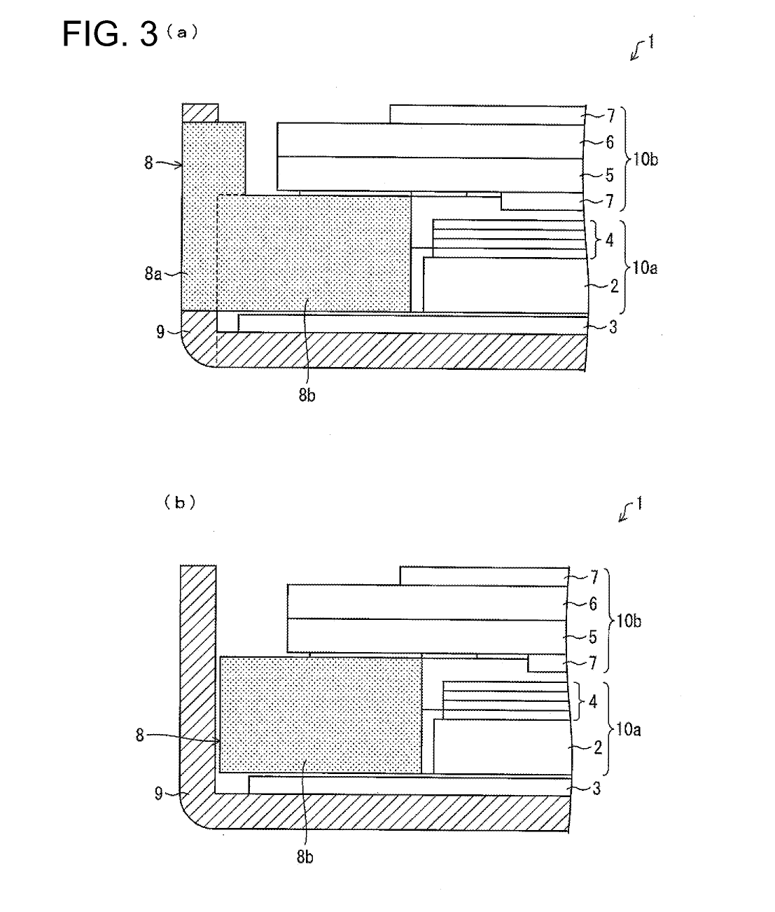

In general, wiring parts are likely to be exposed on the side face of glass plates and the like included in a liquid crystal panel and, in such a case, an electrical short occurs when those wiring parts come into contact with the bezel made of metal, which may cause an adverse effect in display quality. Further, it is desirable to protect the glass plates of the liquid crystal panel. Thus, the liquid crystal display device 1 according to the present embodiment obtains the insulation between the liquid crystal panel 10b and the bezel 9 by using the frame 8. The detailed descriptions will be explained with reference to FIG. 3. FIG. 3(a) is a partial cross-sectional view of the liquid crystal display device 1 showing a part on which an insulating portion 8a of the frame 8 is formed, and FIG. 3(b) is a partial cross-sectional view of the liquid crystal display device 1 showing a part on which an insulating portion 8a of the frame 8 is not formed.

As shown in FIG. 2(a), the bezel 9 of the present embodiment is a rectangular housing and a plurality of slits are formed in the side face thereof. As shown in FIG. 2(b), the frame 8 of the present embodiment is a rectangular frame, and a plurality of insulating portions 8a are formed in the side face thereof. Specifically, the frame 8 includes a frame portion 8b having a shape along inside of a side face of the bezel 9, and the plurality of the insulating portions 8a which protrude to an outside are formed in an outer edge area. The insulating portions 8a are projections formed from an outer side face of the frame portion 8b toward an upper face, and have a height almost reaching into the liquid crystal panel 10b. The frame 8 may be integrally formed by the insulating portions 8a and the frame portion 8b, or the frame 8 may be formed by fixing the insulating portions 8a to the frame portion 8b.

In such a case, a width of the insulating portion 8a of the frame 8 is formed approximately the same as a width W of a slit in the bezel 9, and the insulating portion 8a of the frame 8 fits into the slit in the bezel 9. Thus, the partial cross-sectional view of the part on which the insulating portion 8a of the frame 8 is formed is shown in FIG. 3(a), and an outer side face of the insulating portion 8a and a side face of the bezel 9 are approximately on the same plane. A portion formed on the upper side of the frame portion 8b in the insulating portion 8a faces toward a side face of the liquid crystal panel 10b. On the other hand, the partial cross-sectional view of the part on which the insulating portion 8a of the frame 8 is not formed is shown in FIG. 3(b), and the frame portion 8b is disposed along inner side face of the bezel 9.

In such a case, a thickness of a portion which is formed in the upper side of the frame portion 8b of the insulating portion 8a and which is a portion facing the liquid crystal panel 10b is greater than a thickness of the bezel. Thus, the inner side face of the insulating portion 8a is closer to the liquid crystal panel 10b than the inner side face of the bezel 9. As a result, it is possible to prevent the bezel 9 from coming into contact with the liquid crystal panel 10b and to obtain the insulation between the bezel 9 and the liquid crystal panel 10b.

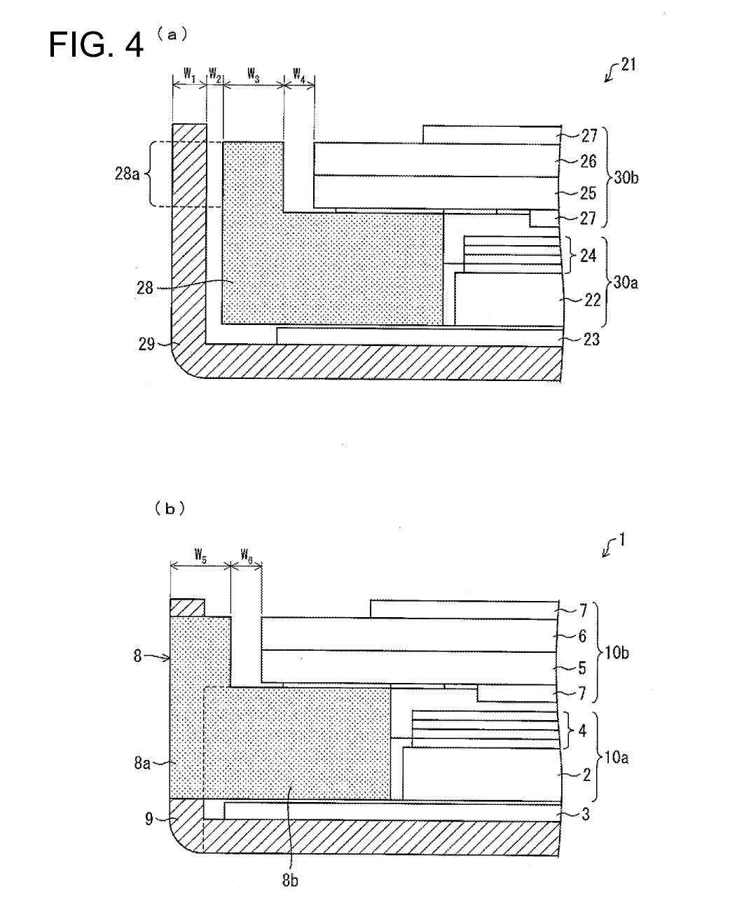

Here, because the insulating portion 8a of the frame 8 fits into the slit of the bezel 9, an outer side face of the frame 8 (the insulating portion 8a) and an outer side face of the bezel 9 are approximately the same plane. Thus, compared to the conventional configuration, the liquid crystal display device 1 makes it possible to narrow the frame area because the outer side face (an inner side face) of the bezel 9 is located to the inside (inside of the bezel 9). Effects of this will be described with concrete numerical values. FIG. 4(a) is a partial cross-sectional view of a conventional liquid crystal display device 21, and FIG. 4(b) is a partial cross-sectional view of the liquid crystal display device 1 according to the present embodiment.

In the conventional liquid crystal display device 21 shown in FIG. 4(a), it is assumed that a bezel width W₁ is 0.2 mm, a clearance W₂ between a bezel 29 and a frame 28 is 0.1 mm, a frame width W₃ (a width of an insulating portion 28a) is 0.3 mm, and a clearance W₄ between a frame 28 and a liquid crystal panel 30b. An outline tolerance of the bezel 29 is assumed to be ±0.1 mm, and an outline tolerance of the frame 28 is assumed to be ±0.1 mm. In this case, a size of the frame area of the liquid crystal display device 21 is determined to be 0.9 mm (=W₁+W₂+W₃+W₄). The frame width W₃ of 0.3 mm is a standard size in mold products. Further, the clearance W₂ is determined by dividing a sum of the outline tolerance of the bezel 29 and the outline tolerance of the frame 28 by two.

On the other hand, in the liquid crystal display device 1 according to the present embodiment shown in FIG. 4(b), it is assumed that a frame width W₅ (a width of the insulating portion 8a) is 0.3 mm, and a clearance W₆ between the frame 8 and the liquid crystal panel 10b is 0.3 mm. The frame width W₅ is determined by adding a bezel width W₁ and a clearance W₂ between the bezel 29 and the frame 28. In this case, a size of a frame area of the liquid crystal display device 1 is determined as 0.6 mm (=W₅+W₆).

Thus, in the above example, the liquid crystal display device 1 according to the present embodiment makes it possible to narrow the frame area by 0.3 mm as compared to the conventional liquid crystal display device 21. This is because, as compared to the conventional liquid crystal display device 21, the outer side face (an inner side face) of the bezel 9 can be shifted inward (inside of the bezel 9) without changing the position of the frame 8, by way of fitting the insulating portion 8a of the frame 8 into the slit of the bezel 9, thereby achieving a narrowed frame.

In the above example, the frame width W₅ of the frame 8 is determined by adding a bezel width W₁ and a clearance W₂. By this configuration, even when the outer dimension of the bezel 9 is the smallest dimension permissible for the outline dimension, and even when the outer dimension of the frame 8 is the largest dimension permissible for the outline dimension, the frame width W₅ can be made greater than the bezel width W₁. Thus, even if there are some errors in the outline dimensions of the frame 8 and the bezel 9, it is possible to reliably obtain the insulation between the bezel 9 and the liquid crystal panel 10b. In the present embodiment, the configuration is not limited thereto as long as at least the frame width W₆ can be greater than the bezel width W₁.

(Position of Insulating Portion 8a)

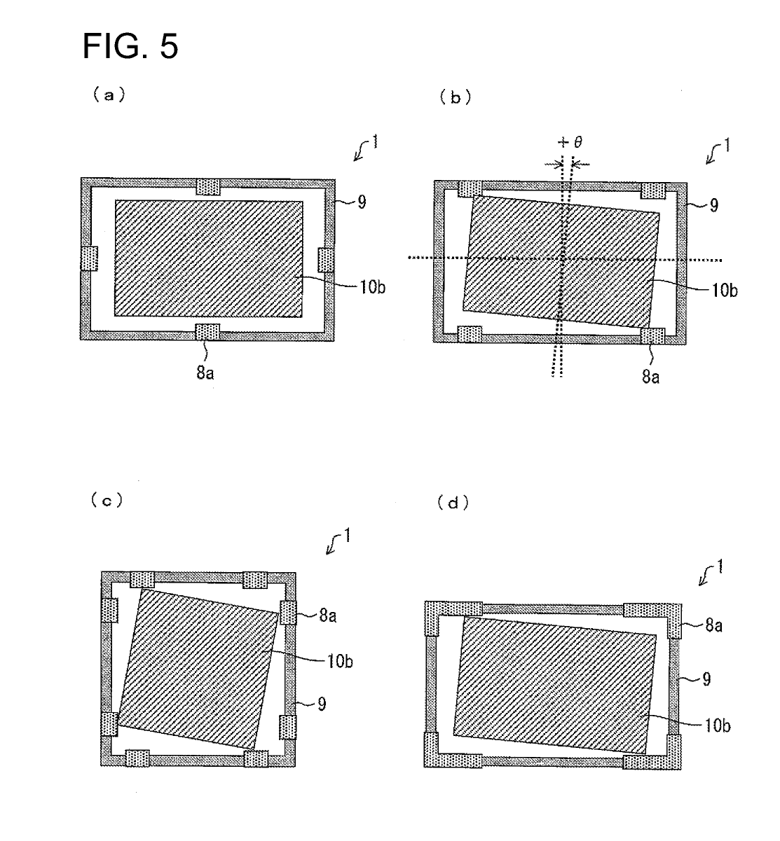

Positions of the frame 8 on which the insulating portions 8a are formed will be described below. FIGS. 5(a) to 5(d) show arrangement examples of the insulating portions 8a of the frame 8.

If the planar light source device 10a is not fixed to the liquid crystal panel 10b with a double-sided adhesive tape and the like, as shown in FIG. 5(a), at least one insulating portion 8a of the frame 8 is preferably formed on each side of the frame 8 in order to prevent the bezel 9 from coming into contact with the liquid crystal panel 10b. Even more preferably, two insulating portions 8a are formed on each side of the frame 8 and are respectively formed at positions close to each corner of the frame 8. By this configuration, it is possible to prevent the liquid crystal panel 10b from coming into contact with the bezel 9, even if the position of the liquid crystal panel 10b is shifted in a diagonal direction rather than up, down, left or right. Here, the positions close to the corner of the frame are positions in which the corners of the liquid crystal panel 10b may possibly come into contact with the bezel 9, and specifically, such positions are located within 10 mm from the corners of the frame. In such a case, among two end portions in parallel with a width direction of the insulating portion 8a of the frame 8, at least one end portion closer to the corner only can be formed within 10 mm from the corner. Thus, in the bezel 9, the slit is formed such that one of the two end portions parallel to a thickness direction of the side face of the bezel 9 in which the slit is formed, which is closer to a corner, is formed at least within 10 millimeters from the corner. By forming the insulating portion 8a (slit) in such a position, even if a position of the liquid crystal panel 10b is shifted in a diagonal direction, the liquid crystal panel 10b can surely be prevented from coming into contact with the bezel 9.

On the other hand, if the planar light source device 10a and the liquid crystal panel 10b are fixed to each other with a double-sided tape and the like, and if a misalignment θ occurs when the planar light source device 10a and the liquid crystal panel 10b are fixed to each other, it is highly possible that the corners of the liquid crystal panel 10b come into contact with the bezel 9. Therefore, it is preferable that the insulating portion 8a of the frame 8 is formed at the corners of the frame 8 or at the positions closer to the corners.

For example, if the liquid crystal panel 10b has a rectangular shape as shown in FIG. 5(b) and a misalignment θ occurs when the planar light source device 10a and the liquid crystal panel 10b are fixed to each other, it is highly possible that the corners of the liquid crystal panel 10b come into contact with a longitudinal face of the bezel 9. Thus, in such a case, as shown in FIG. 5(b), the insulating portions 8a are preferably formed at positions near each corner of respective longitudinal sides of the frame 8. As described above, the positions near the respective corners are the positions within 10 mm from the respective corners of the frame.

On the other hand, if the liquid crystal panel 10b has a square shape as shown in FIG. 5(c), if a misalignment θ occurs when the planar light source device 10a and the liquid crystal panel 10b are fixed to each other, it is highly possible that the corners of the liquid crystal panel 10b come into contact with all side faces of the bezel 9. Thus, in such a case, as shown in FIG. 5(c), the insulating portions 8a are preferably formed at positions near each corner of all sides of the frame 8. The positions near the respective corners are the positions within 10 mm from the respective corners of the frame.

As shown in FIG. 5(d), the frame 8 may include one insulating portion 8a formed from one side to the other side at each corner of the frame 8. Such a configuration can be used for both of the cases in which the planar light source device 10a and the liquid crystal panel 10b are fixed to each other with a double-sided tape and are not fixed to each other.

### Embodiment 2

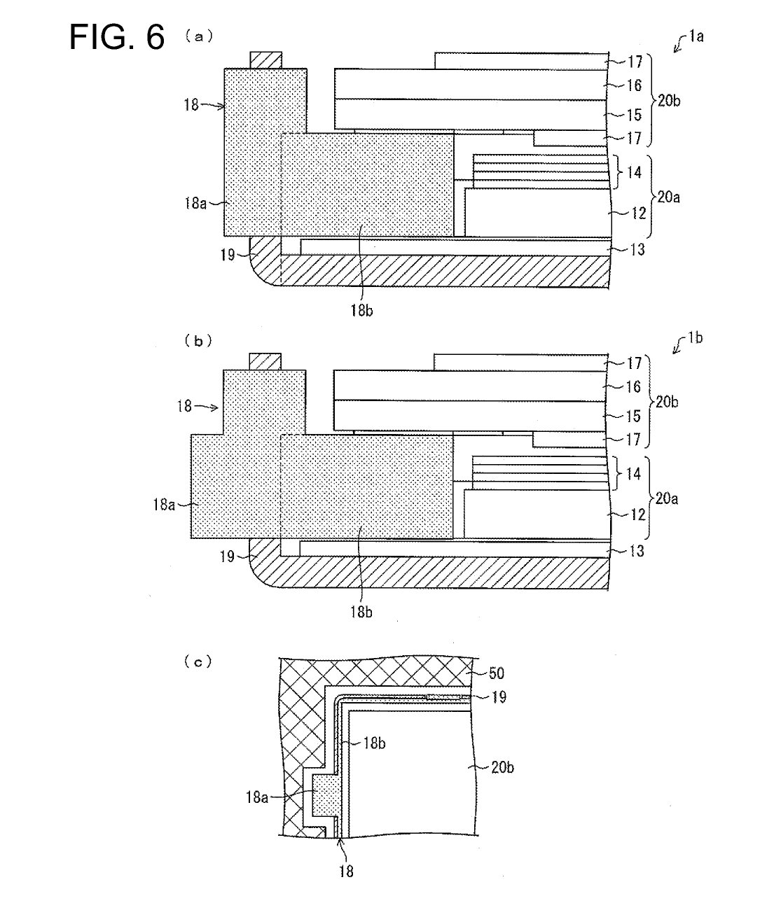

A configuration of a liquid crystal display device according to the present embodiment will be described with reference to FIG. 6. FIG. 6(a) is a partial cross-sectional view showing a liquid crystal display device 1a according to the present embodiment, FIG. 6(b) is a partial cross-sectional view showing a liquid crystal display device 1b which modified the liquid crystal display device 1a, and FIG. 6(c) is a layout plan showing an end product into which the liquid crystal display device 1a or the liquid crystal display device 1b is built.

In the first embodiment, although the outer side face of the insulating portion 8a and the side face of the bezel 9 are formed on approximately the same plane, the present invention is not limited thereto. As shown in FIG. 6(a), in the liquid crystal display device 1a according to the second embodiment, an outer side face of an insulating portion 18a and an outer side face of a bezel 19 are not formed on approximately the same plane, and the outer side face of the insulating portion 18a protrudes from the outer side face of the bezel 19 towards an exterior (towards outside of an outer side face of the liquid crystal display device 1a.) The configuration other than this is the same as the liquid crystal display device 1 of the first embodiment, and thus the thickness of a portion of the insulating portions 18a formed at an upper side of a frame portion 18b, which are portions facing to a liquid crystal panel 20b, is greater than a thickness of a bezel. Therefore, the inner side face of the insulating portion 18a is closer to the liquid crystal panel 20b than the inner side face of the bezel 19.

The liquid crystal display device 1b shown in FIG. 6(b) is partially modified from the liquid crystal display device 1a shown in FIG. 6(a), and a step is formed on the outer side face of the insulating portion 18a which protrudes from the outer side face of the bezel 19 towards an exterior. If the insulating portion 18a protrudes towards the exterior as the liquid crystal display device 1a shown in FIG. 6(a) or the liquid crystal display device 1b shown in FIG. 6(b), the step can be used as a positioning when the liquid crystal display device 1a or the liquid crystal display device 1b is built into the end product such as a cellular phone, a video game device, or the like. Specifically, as shown in FIG. 6(c), by protruding only a part of the insulating portion 18a of the frame 18 towards an exterior, such a configuration can be used as a guide mark when the liquid crystal display device 1a or the liquid crystal display device 1b is built into a fixing frame 50 of the end product.

Thus, the guide mark used when the liquid crystal display device 1a or the liquid crystal display device 1b is built into the fixing frame 50, is formed from a part of the insulating portion 18a of the frame 18 and is fitted into the fixing frame 50. Therefore, compared to the conventional configuration, an advantage that the outer side face (the inner side face) of the bezel 9 can be shifted inward (inside of the bezel 9) without a change in the position of the frame 8, and the effect that it is possible to narrow the frame areas (area other than a display area) in the liquid crystal display devices 1a and 1b can be provided as well.

The present invention is not limited to the embodiments described above, and various modifications can be made without departing from the scope of the claims. Therefore, embodiments obtained by appropriately combining the techniques disclosed in different embodiments are included in the technical scope of the present invention.

### Summary of Embodiments

As described above, a display device according to one aspect of the present embodiment includes: a planar light source device; a display panel; a bezel that houses the planar light source device and the display panel, the bezel being made of metal and having a plurality of slits in side faces of the bezel; and a frame that includes a frame portion that surrounds the planar light source device inside of the bezel, the frame portion having the display panel placed thereon such that the display panel is disposed over the planar light source device, and a plurality of insulating portions that are formed in an outer edge of the frame portion, the plurality of insulating portions individually being fitted into the plurality of slits respectively, a side face of each of the plurality of insulating portions respectively facing a side face of a display panel being closer than a face of the bezel facing the side face of the display panel to the display panel.

By the above-mentioned configuration, the inner side face of the insulating portion is closer to the display panel than the inner side face of the bezel. This prevents the bezel from coming into contact with the display panel and enables the insulation of the bezel from the display panel. Here, because the insulating portion of the frame fits into the slit of the bezel, compared to the conventional configuration, the outer side face (the inner side face) of the bezel is located to the inside (inside of the bezel) without a change in the position of the frame. This makes it possible to narrow the frame of the display device.

In particular, the display device of one aspect of the present embodiment achieves a narrower frame area of the display device by only using the same frame as a conventional display device. Therefore, because the same components can be used as the conventional display, the display device of one aspect of the present embodiment can be assembled with ease and the manufacturing cost can be kept low. Thus, one aspect of the present invention can provide a narrower frame area with the improved shape.

Further, in the display device of one aspect of the present embodiment, each of the insulating portions has a thickness that is determined by adding a thickness of the side face of the bezel and a length that is determined by dividing a sum by two, the sum being determined by adding an outline tolerance of the bezel and an outline tolerance of the frame.

By the above-mentioned configuration, even if the outer dimension of the bezel can be the allowable smallest dimension as an outer dimension and the outer dimension of the bezel can be the allowable largest dimension as an outline dimension, the inner side face of the insulating portion is closer to the display panel than an inner side face of the bezel. Thus, even if there are some errors in the outline dimensions of the frame and the bezel, it is possible to reliably obtain the insulation between the bezel and the display panel.

Furthermore, in the display device of one aspect of the present embodiment, each of the side faces of the bezel includes at least one slit.

By the above-mentioned configuration, the bezel can avoid making contact with the display panel by providing at least one insulating portion in each side of the frame.

Further, in the display device of one aspect of the present embodiment each of the side faces of the bezel may include two slits, one slit may include two end portions parallel to a thickness direction of the side face in which the one slit is formed, the one slit being formed such that one end portion of the one slit closer to one corner formed with the side faces is formed at a position less than or equal to ten millimeters from the one corner, and another slit may include two end portions parallel to the thickness direction of the side face in which the another slit is formed of the bezel, the another slit being formed such that one end portion of the another slit closer to one corner formed with the side faces is formed at a position less than or equal to ten millimeters from the another corner.

According to the above-mentioned configuration, by forming two insulating portions in respective side of the frame at a position close to each corner, it is possible to prevent the bezel from coming into contact with the display panel when the position of the display panel is shifted not only in all directions of up, down, left and right but also in a diagonal direction.

Furthermore, in the display device of one aspect of the present embodiment, the display panel may have a rectangular shape, the planar light source device and the display panel may be fixed to each other, each of side faces in a longitudinal direction of the bezel may include two slits, one slit may include two end portions parallel to a thickness direction of the side face in which the one slit is formed, the one slit being formed such that one end portion of the one slit closer to one corner formed with the side faces is formed at a position less than or equal to ten millimeters from the one corner, and another slit may include two end portions parallel to the thickness direction of the side face in which the another slit is formed, the another slit being formed such that one end portion of the another slit closer to one corner formed with the side faces is formed at a position less than or equal to ten millimeters from the another corner.

If the planar light source device and the display panel are fixed with a double-sided tape and the like, and a misalignment θ occurs when the planar light source device and the display panel are fixed to each other, it is highly possible that the corners of the display panel come to contact with the bezel. For example, if the display panel has a rectangular shape, a misalignment θ occurs when the planar light source device and the display panel are fixed to each other, it is highly possible that the corners of the display panel come to contact with the side face in a longitudinal direction of the bezel. According to the above-mentioned configuration, by forming insulating portion at near each corner of respective long side of the frame (at the position within 10 mm from the each corner), it is possible to obtain the insulation between the display panel and the bezel.

Further, in the display device of one aspect of the present embodiment, in each corner of the bezel, one slit may be formed from one of side faces forming the corner to another of the side faces.

The above-mentioned configuration can be used for both of the cases in which the planar light source device and the display panel are fixed to each other with a double-sided adhesive tape and the like, and are not fixed to each other.

Furthermore, in the display device of one aspect of the present embodiment, each of the insulating portions may protrude toward an outside in a thickness direction of the side face of the bezel, and, in each of the insulating portions, one face opposite to another face facing one side face of the display panel may be far from the display panel than, in the bezel, one face opposite to another face facing the one side face of the display panel.

According to the above-mentioned configuration, if the insulating portion protrudes towards an exterior, it can be used as a guide mark when the display device is built into the end product such as a cellular phone, a video game device, or the like. Specifically, by protruding only a part of the insulating portion of the frame towards the exterior, such projections can be used as a guide mark when the display device is built into the fixing frame of the end product.

The specific embodiments and examples provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The present invention can be suitably used as a display of mobile information devices such as a laptop, a mobile information terminal, a video game device, a mobile phone and so on.

### DESCRIPTION OF REFERENCE CHARACTERS

1, 1a, 1b liquid crystal display device

2, 12 light guide plate

3, 13 reflection film

4, 14 optical film

5, 15 glass plate

6, 16 glass plate

7, 17 polarizing plate

8, 18 frame

8a, 18a insulating portion

8b, 18b frame portion

9, 19 bezel

10a, 20a planar light source device

10b, 20b liquid crystal panel

1. A display device, comprising:
a planar light source device;
a display panel;
a frame that is located around the planar light source device and has the display panel placed on a front primary surface of the frame such that the display panel is disposed over the planar light source device; and
a bezel that houses the planar light source device, the display panel, and the frame, the bezel being made of metal and having a plurality of openings in side walls of the bezel,
wherein the frame has a plurality of insulating portions, each of the plurality of insulating portions being formed in an outer edge of the frame, the plurality of insulating portions being individually fitted into the plurality of openings of the bezel, respectively, and individually including an extended portion extending upwardly from the front primary surface of the frame, an inner side face of the extended portion being facing a side face of the display panel, the inner side face of the extended portion being closer to said side face of the display panel than a corresponding inner side face of the bezel in a plan view.

2. The display device according to claim 1, wherein each of the extended portions is formed so as to have a thickness that is determined by adding a thickness of a side wall of the bezel and a length that is determined by dividing a sum by two, said sum being determined by adding an outline tolerance of the bezel and an outline tolerance of the frame.

3. The display device according to claim 1, wherein each of side walls of the bezel includes at least one opening.

4. The display device according to claim 3,
wherein each of the side walls of the bezel includes two openings,
wherein one opening includes two end portions parallel to a thickness direction of a side wall in which said one opening is formed, said one opening being formed such that one end portion of said one opening closer to one corner of the bezel is formed at a position less than or equal to ten millimeters from said one corner of the bezel, and
wherein another opening includes two end portions parallel to the thickness direction of the side wall in which said another opening is formed of the bezel, said another opening being formed such that one end portion of said another opening closer to another corner of the bezel is formed at a position less than or equal to ten millimeters from said another corner of the bezel.

5. The display device according to claim 1,
wherein the display panel has a rectangular shape,
wherein the planar light source device and the display panel are fixed to each other,
wherein each of side walls in a longitudinal direction of the bezel includes two openings,
wherein one opening includes two end portions parallel to a thickness direction of a side wall in which said one opening is formed, said one opening being formed such that one end portion of said one opening closer to one corner of the bezel is formed at a position less than or equal to ten millimeters from said one corner of the bezel, and
wherein another opening includes two end portions parallel to the thickness direction of the side wall in which said another opening is formed, said another opening being formed such that one end portion of said another opening closer to said another corner of the bezel is formed at a position less than or equal to ten millimeters from said another corner of the bezel.

6. The display device according to claim 1,
wherein each corner of the bezel formed with two side walls of the bezel includes one opening that extends from one of side walls to another side wall in said each corner.

7. The display device according to claim 1,
wherein each of the extended portions protrudes toward an outside in a thickness direction of the side wall of the bezel,
wherein an extended portion has an outer side face opposite to an inner side face of the extended portion facing a side face of the display panel,
wherein the bezel has an outer side face opposite to an inner side face of the bezel facing said side face of the display panel, and
wherein the outer side face of the extended portion is further from said side face of the display panel than the outer side face of the bezel in a plan view.
